(19) United States
(12) Patent Application Publication
(10) Pub. No.: US 2025/0146927 A1
(43) Pub. Date: May 8, 2025

(54) MEASUREMENT INSTRUMENT, MEASUREMENT DEVICE, MEASUREMENT SYSTEM, AND MEASUREMENT METHOD

(71) Applicant: HORIBA Advanced Techno, Co., Ltd., Kyoto-shi, Kyoto (JP)

(72) Inventors: Issei KOBAYASHI, Kyoto-shi (JP); Kazuhiro IRIE, Kyoto-shi (JP); Wataru KINOSHITA, Kyoto-shi (JP); Kentaro INOUE, Kyoto-shi (JP)

(21) Appl. No.: 18/730,217

(22) PCT Filed: Feb. 1, 2023
(86) PCT No.: PCT/JP2023/003169

§ 371 Date: Jan. 9, 2025

(30) Foreign Application Priority Data
Feb. 1, 2022 (JP) 2022-013952

(51) Int. Cl. G01N 21/15; G01N 21/01; G01N 21/05

(52) U.S. Cl. CPC G01N 21/15; G01N 21/05; G01N 2021/0137; G01N 2021/052; G01N 2021/152

(57) ABSTRACT

A measurement instrument comprises a cylindrical cell that stores a measurement fluid, a light source that is arranged outside the cell and irradiates the measurement fluid with inspection light, a detector that is arranged outside the cell and detects transmitted light or scattered light generated from the measurement fluid, a cleaning mechanism that is arranged inside the cell and cleans an inner peripheral surface of the cell, and a drive mechanism that rotates the cell about a central axis.

### TECHNICAL FIELD

The present application relates to a measurement instrument, a measurement device, a measurement system, and a measurement method.

### BACKGROUND ART

In a measurement instrument that measures fluid using light, the fluid stored in the cell is irradiated with light from the outside of the cell, and transmitted light or scattered light generated from the fluid is detected. In doing so, inner walls of the cells need to be cleaned because they are contaminated by fluid-derived dirt. Conventionally, for example, as in Patent Document 1, a cleaning body (a wiper, a brush, or the like) that moves along an inner wall is provided in a cell to clean the inner wall of the cell.

However, in the case of a measurement instrument that performs continuous measurement, a moving cleaning body blocks an optical path, and thus a time during which light cannot be detected occurs at the time of measurement. Furthermore, in a fluid with significant contamination, the cleaning frequency tends to be high. In continuous measurement, it is desired that there is no light blocking time.

### PRIOR ART DOCUMENT

### Patent Document

Patent Document 1: JP-A-2014-157149

### SUMMARY OF THE INVENTION

### Problems to be Solved by the Invention

Therefore, an object is to provide a measurement instrument, a measurement device, a measurement system, and a measurement method capable of continuously measuring fluid without light emitted from a light source being blocked by a cleaning body.

### Means for Solving the Problems

A measurement instrument includes:
a cylindrical cell that stores a measurement fluid;
a light source that is arranged outside the cell and irradiates the measurement fluid with inspection light;
a detector that is arranged outside the cell and detects transmitted light or scattered light generated from the measurement fluid;
a cleaning mechanism that is arranged inside the cell and cleans an inner peripheral surface of the cell; and
a drive mechanism that rotates the cell about a central axis.

A measurement device includes:
the measurement instrument; and
a main body to which the measurement instrument is attached and detached.

A measurement system includes:
the measurement device; and
a communication device capable of communicating with the measurement device.

A measurement method uses a measurement instrument, the measurement instrument including:
a cylindrical cell that stores a measurement fluid;
a light source that is arranged outside the cell and irradiates the measurement fluid with inspection light;
a detector that is arranged outside the cell and detects transmitted light or scattered light generated from the measurement fluid;
a cleaning mechanism that is arranged inside the cell and cleans an inner peripheral surface of the cell; and
a drive mechanism that rotates the cell about a central axis.

### BRIEF DESCRIPTION OF THE DRAWINGS

FIG. 1 is an overall schematic view of a measurement system according to an embodiment.

FIG. 2 is an overall schematic view of the measurement system according to the embodiment, illustrating a state in which one measurement instrument is detached from a main body.

FIG. 3 is a diagram illustrating a fluid flow path of a measurement device according to the embodiment.

FIG. 4 is a control block diagram of the measurement system according to the embodiment.

FIG. 5 is a control block diagram of the measurement system according to the embodiment.

FIG. 6 is a perspective view of a measurement instrument according to the embodiment.

FIG. 7 is a perspective view of a measurement unit in a state where a case and a cover are removed.

FIG. 8 is a cross-sectional view taken along line VIII-VIII in FIG. 7.

FIG. 9 is a cross-sectional view taken along line IX-IX of FIG. 7.

FIG. 10 is a perspective view of a base of the measurement instrument.

FIG. 11 is a front view of the base of the measurement instrument.

FIG. 12 is a perspective view of a drive mechanism of the measurement instrument.

### MODE FOR CARRYING OUT THE INVENTION

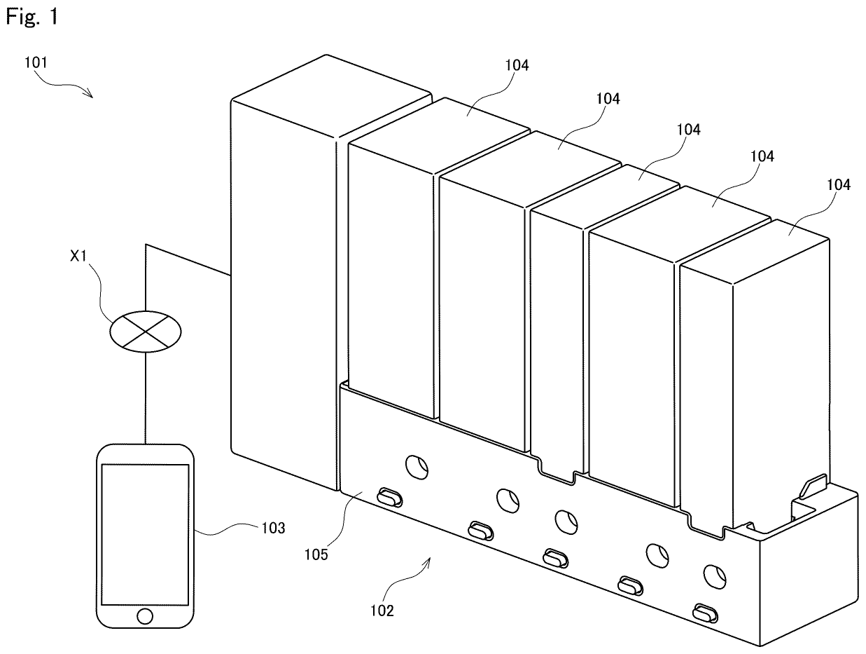

Hereinafter, an embodiment of a measurement system, a measurement device, and a measurement instrument will be described with reference to FIGS. 1 to 12. Note that, in the drawings, dimensional ratios in the drawings do not necessarily coincide with actual dimensional ratios, and the dimensional ratios in the drawings do not necessarily coincide with each other.

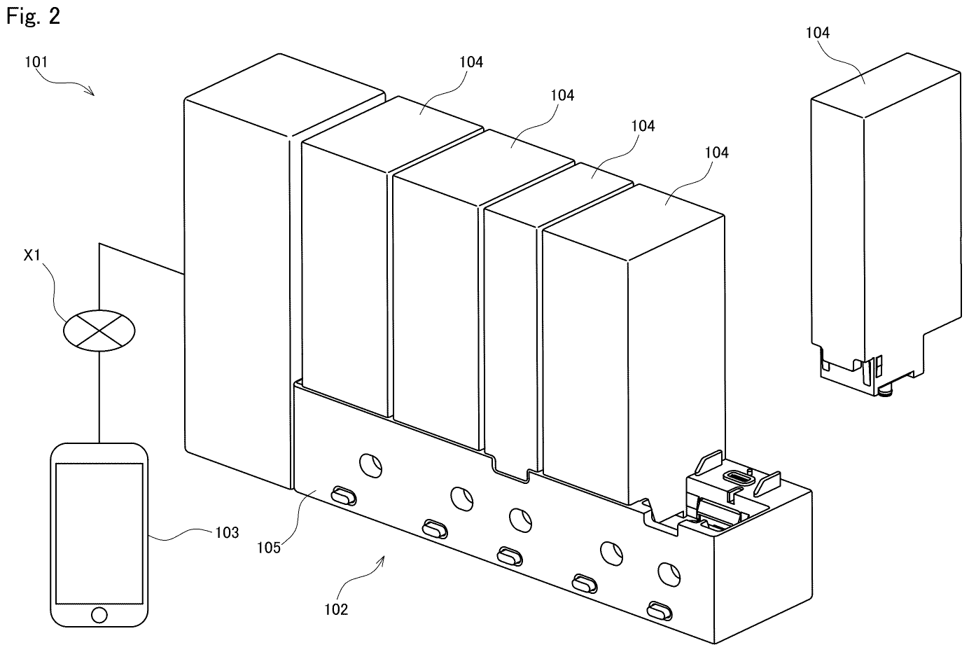

As illustrated in FIGS. 1 and 2, a measurement system 101 may include, for example, a measurement device 102 that measures a fluid and a communication device 103 that can communicate with the measurement device 102 by a communication means X1. Note that the fluid is not particularly limited, and includes, for example, not only a liquid but also a gas, a mixture of a liquid and a gas, a mixture of a liquid and a solid, and the like.

Although not particularly limited, the communication device 103 may be, for example, a mobile terminal (for example, a smart device, a tablet computer, a notebook personal computer, or the like) as in the present embodiment. In addition, the communication means X1 may be, for example, a wireless communication means such as Wi-Fi or a wireless LAN, or may be, for example, a wired communication means such as a communication cable or a wired LAN.

The measurement device 102 may include, for example, a plurality of (five in the present embodiment) measurement instruments 104 for measuring a fluid, and a main body 105 to which each measurement instrument 104 is attached and detached. Note that the number of the measurement instruments 104 is not particularly limited, and may be, for example, one, two to four, or six or more.

The measurement instrument 104 is not particularly limited as long as it is an instrument that measures a value related to a fluid (for example, a characteristic value, a state value, and the like). For example, when the measurement instrument 104 is a water quality meter that measures a value related to water, the measurement instrument 104 may be, for example, a turbidity meter, a chromaticity meter, a pH meter, a residual chlorine concentration meter, a conductivity meter, a flow meter, a water temperature meter, or the like. Note that the plurality of measurement instruments 104 may measure different values related to the fluid.

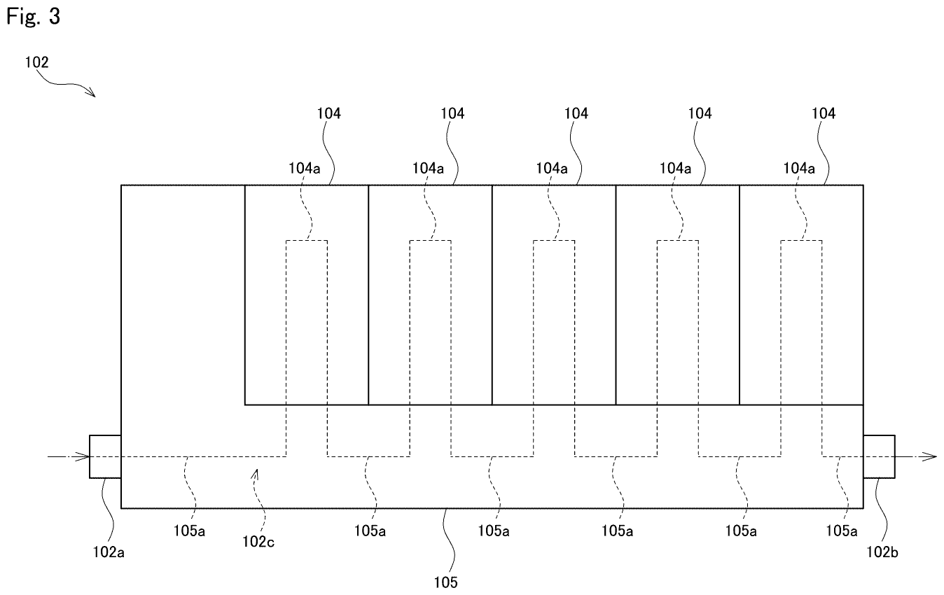

As illustrated in FIG. 3, for example, as in the present embodiment, the measurement device 102 may include an inflow portion 102a into which a fluid flows, an outflow portion 102b from which the fluid flows out, and a flow path 102c through which the fluid flows from the inflow portion 102a to the outflow portion 102b. Note that, although not illustrated, for example, the measurement device 102 may have a structure in which a fluid (for example, a chemical solution for cleaning, a calibration solution for calibration, and the like) different from the fluid to be measured (for example, water) flows through the flow path 102c.

In addition, for example, as in the present embodiment, the measurement instrument 104 may include a measurement flow path 104a through which the fluid flows, the main body 105 may include a main body flow path 105a through which the fluid flows, and the measurement flow path 104a and the main body flow path 105a may constitute the flow path 102c. The measurement flow path 104a and the main body flow path 105a may be connected to each other by attaching the measurement instrument 104 to the main body 105 to form the flow path 102c.

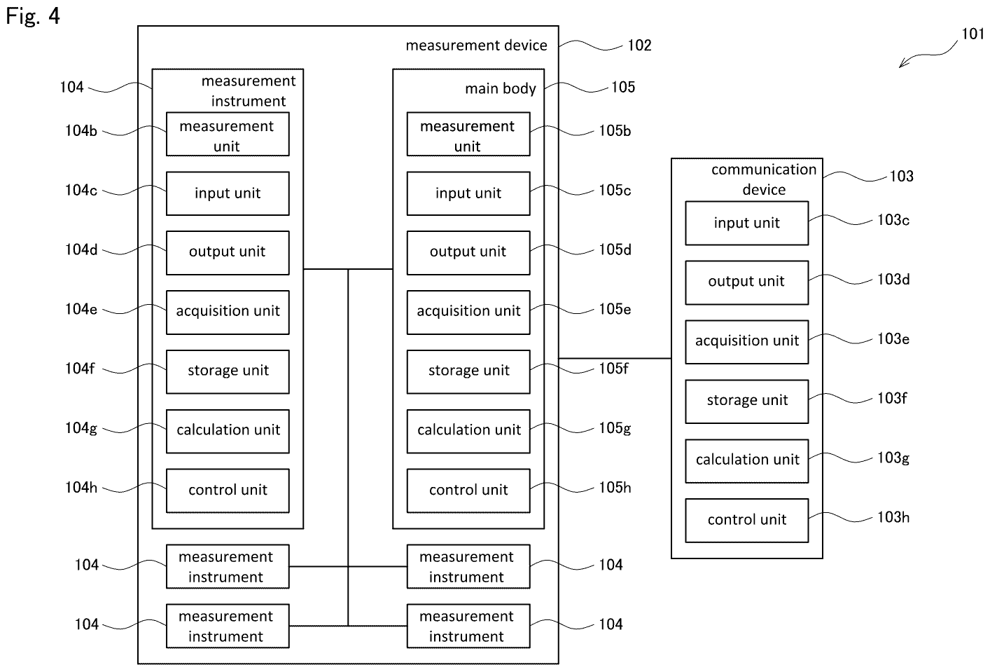

As illustrated in FIG. 4, the measurement instrument 104 and the main body 105 may include, for example, measurement units 104b and 105b, respectively, for measuring a fluid. Then, the measurement device 102 (specifically, each measurement instrument 104 and the main body 105) and the communication device 103 may include, for example, input units 103c, 104c, and 105c to which various data are input, and output units 103d, 104d, and 105d from which various data are output, as in the present embodiment.

In addition, for example, as in the present embodiment, the measurement device 102 (specifically, each measurement instrument 104 and the main body 105) and the communication device 103 may include acquisition units 103e, 104e, and 105e that acquire various data, storage units 103f, 104f, and 105f that store various data, calculation units 103g, 104g, and 105g that calculate various data, and control units 103h, 104h, and 105h that control the devices 102 (104, 105) and 103 on the basis of various data.

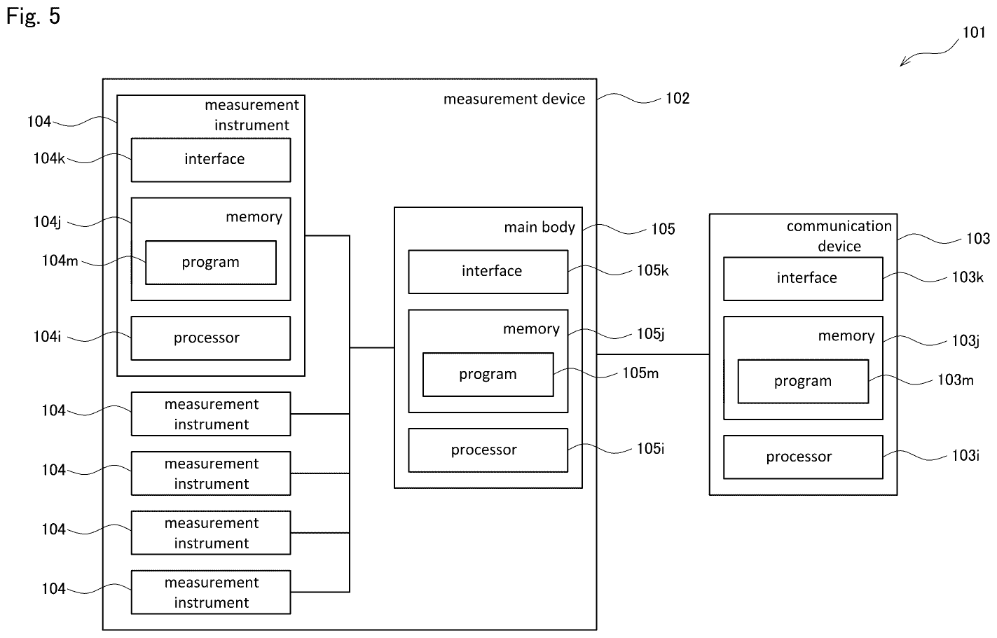

Note that, as illustrated in FIG. 5, the measurement device 102 (specifically, each of the measurement instruments 104 and the main body 105) and the communication device 103 may include processors 103i, 104i, and 105i (for example, the calculation units 103g, 104g, and 105g, and the control units 103h, 104h, and 105h) such as a CPU and an MPU, memories 103j, 104j, and 105j (for example, the acquisition units 103e, 104e, and 105e and the storage units 103f, 104f, and 105f) such as a ROM and a RAM, various interfaces 104k, 105k, and 103k (for example, the acquisition units 103e, 104e, and 105e), and the like.

Then, programs 103m, 104m, and 105m stored in the memories 103j, 104j, and 105j may be executed by the processors 103i, 104i, and 105i, and software and hardware cooperate with each other to implement the calculation units 103g, 104g, and 105g and the control units 103h, 104h, and 105h of the measurement device 102 (specifically, each measurement instrument 104 and the main body 105) and the communication device 103.

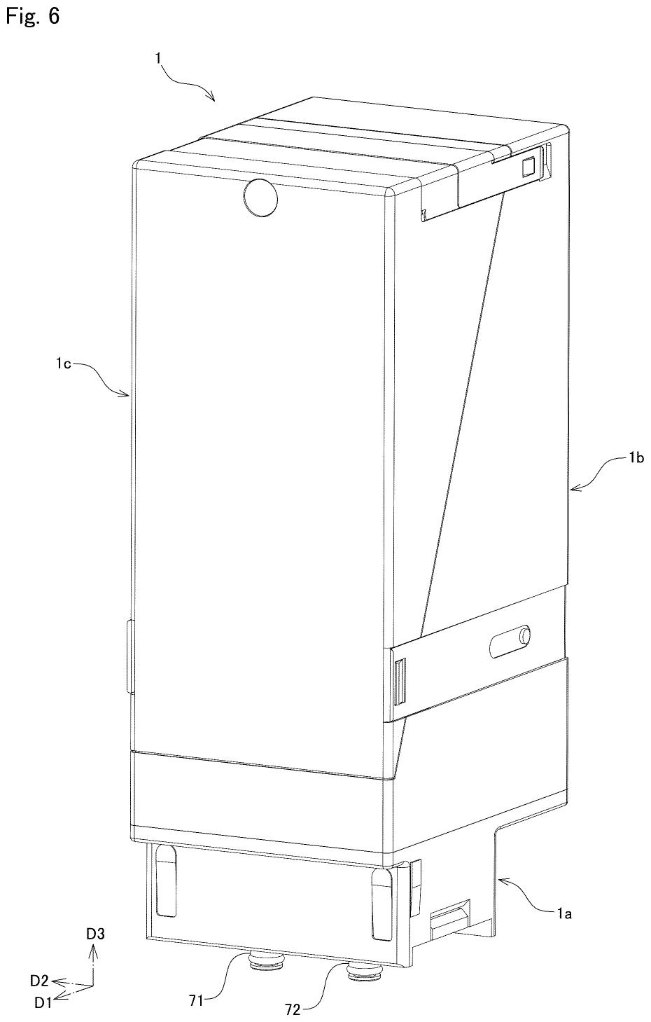

FIG. 6 is a perspective view of the measurement instrument 1 which is one of the plurality of measurement instruments 104 illustrated in FIGS. 1 and 2. As illustrated in FIG. 6, the measurement instrument 1 is formed in a substantially rectangular parallelepiped shape elongated in a vertical direction D3. In the following description, a direction in which an introduction pipe 71 and a discharge pipe 72 (described later) are arranged side by side is referred to as a second lateral direction D2, and a direction orthogonal to the second lateral direction D2 and the vertical direction D3 is referred to as a first lateral direction D1. The measurement instrument 1 includes a measurement unit 1a, and a case 1b and a cover 1c surrounding the measurement unit 1a.

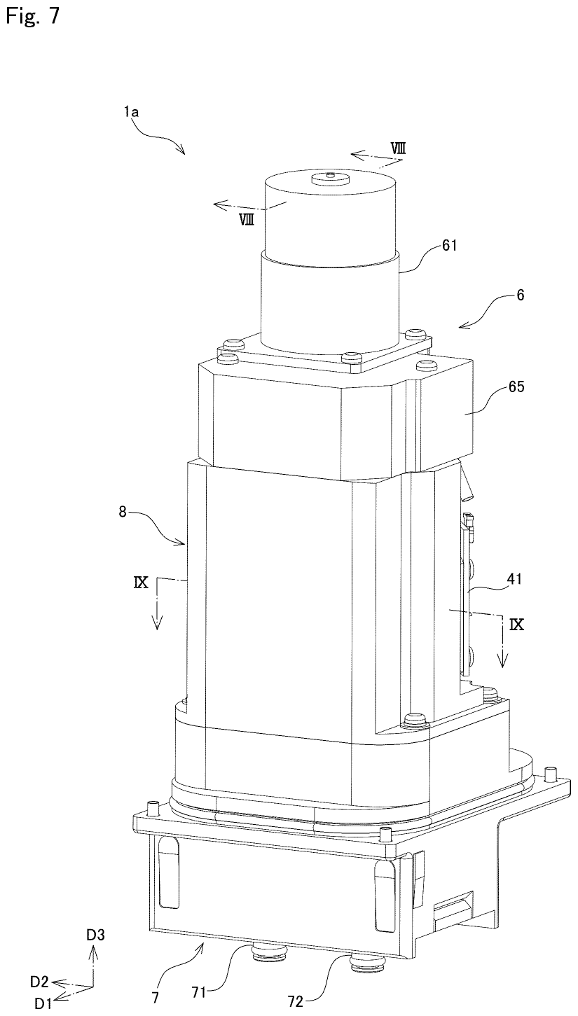

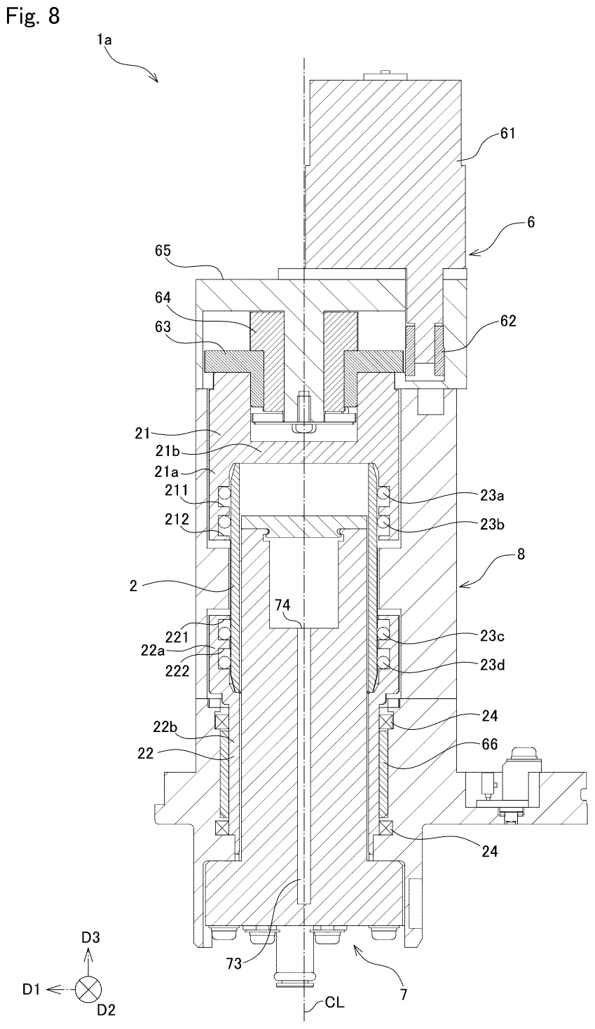

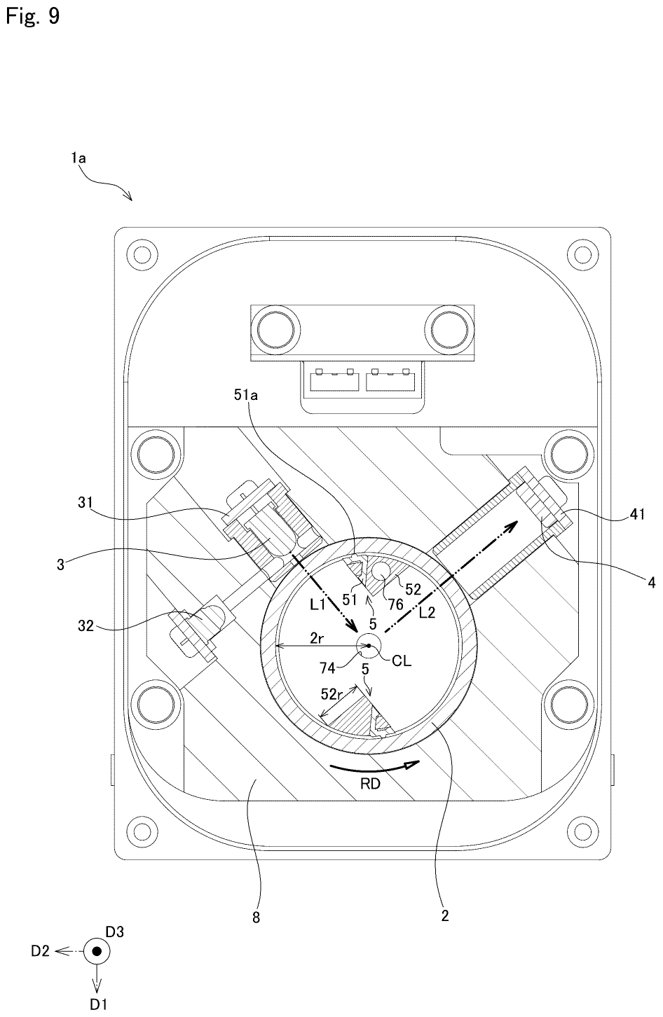

FIG. 7 perspective view is a illustrating the measurement unit 1a in a state where the case 1b and the cover 1c are removed. FIG. 8 is a cross-sectional view taken along line VIII-VIII of the measurement unit 1a illustrated in FIG. 7. FIG. 9 is a cross-sectional view taken along line IX-IX of the measurement unit 1a illustrated in FIG. 7.

The measurement unit 1a includes a cell 2, a light source 3, a detector 4, a cleaning mechanism 5, and a drive mechanism 6. The measurement unit 1a further includes a base 7 connected to the main body 105 and a housing 8.

The cell 2 stores a fluid to be measured (hereinafter referred to as a measurement fluid). The cell 2 is constituted by a light transmissive material. Although not particularly limited, the light transmissive material is glass, an acrylic resin, a fluorine-based resin, a silicon resin, or the like, and is preferably a hard borosilicate glass having excellent translucency.

The cell 2 is formed in a cylindrical shape. A central axis CL of the cell 2 is arranged along a vertical direction D3, and the vertical direction D3 is an axial direction D3 of the cell 2. An outer diameter of the cell 2 is, for example, 34 to 36 mm. A thickness of the cylinder of the cell 2 is constant in the axial direction D3 except for both ends in the axial direction D3. The thickness of the cylinder of the cell 2 is preferably equal to or less than 3 mm, and more preferably equal to or less than 2 mm. The cell 2 is rotated about the central axis CL by the drive mechanism 6.

The first holder 21 and the second holder 22 are connected to both sides of the cell 2 in the axial direction D3. The first holder 21 and the second holder 22 are formed by resin. Although not particularly limited, the resin constituting the first holder 21 is an ABS resin, and the resin constituting the second holder 22 is a POM resin.

The first holder 21 is formed in a cylindrical shape. The first holder 21 includes a cylindrical first connection portion 21a that covers an outer peripheral surface of the cell 2 and a closing portion 21b provided inside the first connection portion 21a. The closing portion 21b closes the upper end of the cell 2.

The first connection portion 21a includes two O-ring grooves 211 and 212 formed apart from each other in the vertical direction D3. The O-ring grooves 211 and 212 are formed in an inner peripheral surface of the first connection portion 21a over the entire circumferential direction. O-rings 23a and 23b are disposed in the O-ring grooves 211 and 212, respectively. The upper O-ring 23a ensures a sealing property between the cell 2 and the first holder 21, and prevents the measurement fluid from leaking to the outside of the cell 2. The lower O-ring 23b increases a frictional force between the cell 2 and the first holder 21, and enables the cell 2 to be rotated by the rotation of the first holder 21.

The second holder 22 is formed in a cylindrical shape. The second holder 22 includes a cylindrical second connection portion 22a covering the outer peripheral surface of the cell 2 and a cylindrical extension portion 22b extending downward from the second connection portion 22a.

The second connection portion 22a includes two O-ring grooves 221 and 222 formed apart from each other in the vertical direction D3. The O-ring grooves 221 and 222 are formed in an inner peripheral surface of the second connection portion 22a over the entire circumferential direction. O-rings 23c and 23d are disposed in the O-ring grooves 221 and 222, respectively. The upper O-ring 23c increases the frictional force between the cell 2 and the second holder 22, and enables the second holder 22 to be rotated by the rotation of the cell 2. The lower O-ring 23d ensures a sealing property between the cell 2 and the second holder 22, and prevents the measurement fluid from leaking to the outside of the cell 2.

An inner peripheral surface of the extension portion 22b is substantially flush with an inner peripheral surface of the cell 2. An outer peripheral surface of the extension portion 22b is sealed by two X-rings 24 arranged apart from each other in the vertical direction D3. The X-ring 24 has an X-shaped cross section, has low friction, and is suitable for sealing between the rotating extension portion 22b and the housing 8.

The light source 3 is arranged outside the cell 2 as illustrated in FIG. 9. The light source 3 is embedded in the housing 8. The light source 3 irradiates the measurement fluid in the cell 2 with inspection light L1. The light source 3 is, for example, a light emitting diode (LED) having a peak wavelength in a near infrared region. The light source 3 is attached to an LED substrate 31, and the LED substrate 31 is attached to the housing 8. Note that, in the present embodiment, an optical lens is not arranged in front of the light source 3 in order to downsize the measurement instrument 1.

A reference light detection unit 32 is arranged on a side of the light source 3. The reference light detection unit 32 detects the intensity of a part of light emitted from the light source 3 as reference light. The intensity of the reference light detected by the reference light detection unit 32 is used to correct the intensity of transmitted light or scattered light obtained by the detector 4.

The detector 4 is arranged outside the cell 2 as illustrated in FIG. 9. The detector 4 is embedded in the housing 8. The detector 4 detects transmitted light or scattered light generated from the measurement fluid in the cell 2. The detector 4 is, for example, a photodiode whose peak sensitivity wavelength is near the peak wavelength of the LED. For example, the detected scattered light is used to measure the turbidity of the fluid, and the detected transmitted light is used to measure the chromaticity of the fluid.

The detector 4 is attached to a photodiode substrate 41, and the photodiode substrate 41 is attached to the housing 8. In the present embodiment, the detector 4 is a scattered light detector that detects scattered light L2 generated from the measurement fluid. The scattered light detector 4 and the light source 3 are arranged at positions shifted by 90° in a rotation direction RD of the cell 2.

The cleaning mechanism 5 is arranged inside the cell 2 as illustrated in FIG. 9. Further, the cleaning mechanism 5 is arranged outside optical paths of the inspection light L1 and the scattered light L2. Specifically, the cleaning mechanism 5 is arranged between the light source 3 and the scattered light detector 4 in the rotation direction RD of the cell 2. The cleaning mechanism 5 is arranged at a position shifted by 45° from each of the light source 3 and the scattered light detector 4 in the rotation direction RD of the cell 2. Accordingly, the cleaning mechanism 5 is not arranged on the optical paths of the inspection light L1 and the scattered light L2, and does not interfere with the measurement.

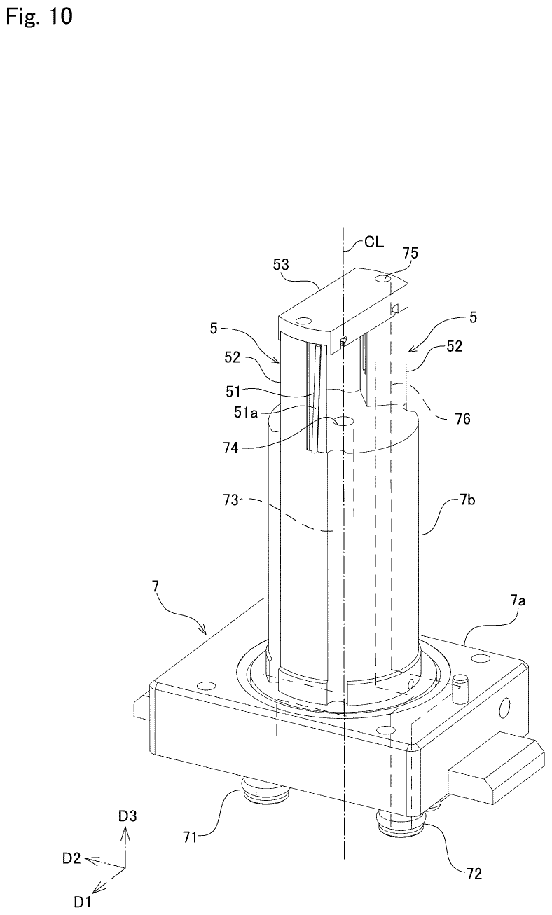

Note that a plurality of the cleaning mechanisms 5 may be provided. In the present embodiment, another cleaning mechanism 5 is provided at a position facing the cleaning mechanism 5 between the light source 3 and the scattered light detector 4 across the central axis CL of the cell 2. At this time, upper ends of the two cleaning mechanisms 5 are connected to each other by a reinforcing member 53 (see FIG. 10).

The cleaning mechanism 5 cleans the inner peripheral surface of the cell 2. Although not particularly limited, the cleaning mechanism 5 includes a wiper 51 that wipes dirt on the inner peripheral surface of the cell 2 and a wiper fixing portion 52 that fixes the wiper 51.

The wiper 51 is formed by an elastic material such as rubber. The wiper 51 has a contact portion 51a in contact with the inner peripheral surface of the cell 2 over a predetermined range in the axial direction D3. The contact portion 51a is arranged at a position overlapping at least the light source 3 and the detector 4 when viewed in the rotation direction RD of the cell 2. Thus, the contact portion 51a of the wiper 51 can wipe the inner peripheral surface of the cell 2 located in front of the light source 3 and the detector 4 as the cell 2 rotates. At this time, the inner peripheral surface of the cell 2 is cleaned by rotating the cell 2 with respect to the cleaning mechanism 5 fixed inside the cell 2, and thus the inspection light L1 emitted from the light source 3 is not blocked by the cleaning mechanism 5, and the measurement fluid can be continuously measured.

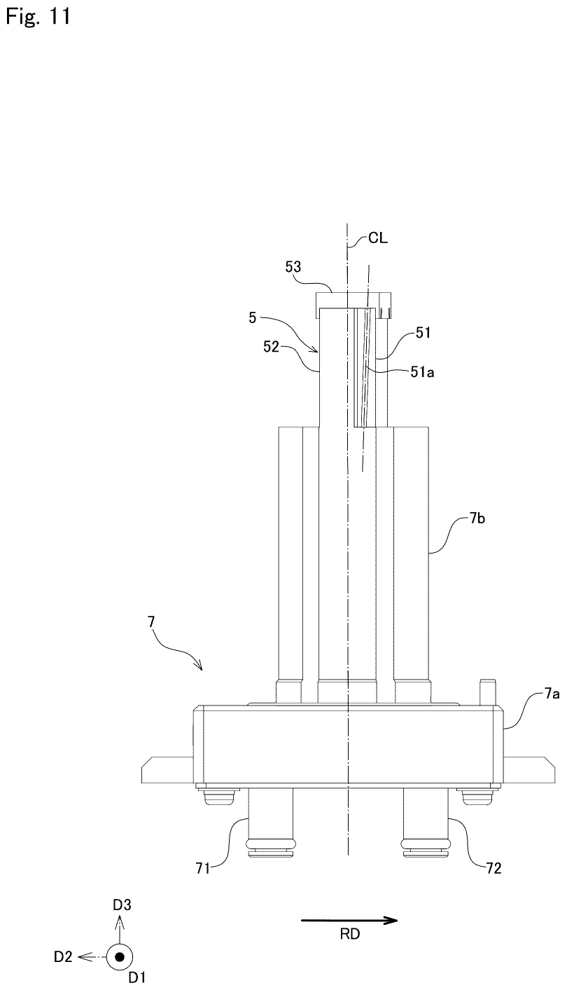

Further, the contact portion 51a is inclined with respect to the central axis CL so that an upper end of the contact portion 51a is positioned ahead of a lower end in the rotation direction RD of the cell 2 (see FIG. 11). Thus, dirt and air collected by the contact portion 51a can be prevented from accumulating below the contact portion 51a.

The wiper fixing portion 52 extends upward from an upper end surface of the base 7. In the present embodiment, the wiper fixing portion 52 is formed integrally with the base 7. As illustrated in FIG. 9, a cross section of the wiper fixing portion 52 is formed in a fan shape. The central angle of the fan shape of the wiper fixing portion 52 is 90°. An outer peripheral surface of the wiper fixing portion 52 has a slight gap with the inner peripheral surface of the cell 2. The contact portion 51a of the wiper 51 protrudes outward from the outer peripheral surface of the wiper fixing portion 52. A radius 52r of the fan shape of the wiper fixing portion 52 is smaller than a radius 2r of the inner peripheral surface of the cell 2 and is about half of the radius 2r. Since the wiper fixing portion 52 has a fan-shaped cross section and is arranged between the light source 3 and the scattered light detector 4 in the rotation direction RD of the cell 2, stray light can be suppressed from being received by the scattered light detector 4, and as a result, more accurate measurement can be performed. When an optical lens is not arranged in front of the light source 3 as in the present embodiment, the inspection light L1 is diffused, and thus it is effective to block the stray light by the wiper fixing portion 52.

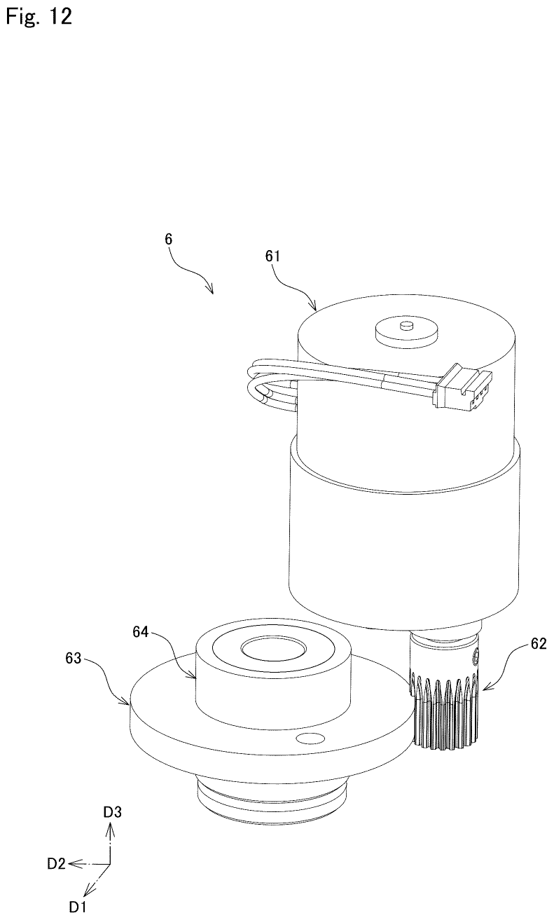

As illustrated in FIGS. 8 and 12, the drive mechanism 6 includes a motor 61, a drive gear 62 rotationally driven by the motor 61, and a driven gear 63 that meshes with the drive gear 62 and rotates.

The motor 61 is fixed to an upper portion of the housing 8 via a gear base 65. The motor 61 is, for example, a stepping motor. The drive gear 62 is attached to a rotation shaft of the motor 61.

The driven gear 63 is rotatably supported by the gear base 65 (not illustrated in FIG. 12) via a bearing 64. An outer diameter of the driven gear 63 is substantially the same as an outer diameter of the first holder 21, and a plurality of teeth (not illustrated in FIG. 12) is formed on an outer peripheral surface of the driven gear 63. The driven gear 63 is coaxially fixed to the first holder 21, and rotates the first holder 21 about the central axis CL of the cell 2. Thus, the drive mechanism 6 can rotate the first holder 21 by rotating the drive gear 62 by the motor 61 and rotating the driven gear 63 by the drive gear 62. As a result, the drive mechanism 6 can rotate the cell 2 fixed to the first holder 21 about the central axis CL.

When the cell 2 rotates about the central axis CL, the inner peripheral surface of the cell 2 is cleaned by the wiper 51. The drive mechanism 6 can continuously or intermittently rotate the cell 2 according to the degree of contamination of the inner peripheral surface of the cell 2.

Note that, as illustrated in FIG. 8, the second holder 22 is rotatably supported by the housing 8 via the bearing 66. The bearing 66 is, for example, a low-friction resin cylindrical member. The bearing 66 is arranged between the two X-rings 24.

The base 7 includes an introduction pipe 71 and a discharge pipe 72 connected to the main body 105 on a bottom surface. The introduction pipe 71 and the discharge pipe 72 are arranged side by side in the second lateral direction D2. As illustrated in FIG. 10, the base 7 includes a rectangular portion 7a to which the housing 8 is attached and a columnar portion 7b extending in the axial direction D3 from the rectangular portion 7a. The columnar portion 7b is covered with the cell 2, the first holder 21, and the second holder 22 (see FIG. 8). An introduction flow path 73 extending in the axial direction D3 is formed at the center of the columnar portion 7b. The introduction flow path 73 communicates with the introduction pipe 71 via a flow path (indicated by broken lines in FIG. 10) formed inside the rectangular portion 7a. The introduction flow path 73 includes an introduction port 74 opened at an upper end surface of the columnar portion 7b. The introduction port 74 introduces the measurement fluid introduced from the introduction pipe 71 into the introduction flow path 73 into the cell 2.

The measurement fluid introduced into the cell 2 is discharged from a discharge port 75. The discharge port 75 is formed on an upper end surface of the reinforcing member 53. The discharge port 75 is located above the optical paths of the inspection light L1 and the scattered light L2. Thus, air accumulated in the upper portion of the cell 2 can be discharged from the discharge port 75, and thus it is possible to prevent the air from being positioned on the optical paths of the inspection light L1 and the scattered light L2 and deteriorating the measurement accuracy.

Further, the discharge port 75 is positioned above the introduction port 74. That is, the introduction port 74 is arranged on one side (lower side) in the axial direction D3 with respect to the inspection light L1 and the scattered light L2, and the discharge port 75 is arranged on the other side (upper side) in the axial direction D3 with respect to the inspection light L1 and the scattered light L2. Thus, the measurement fluid introduced from the introduction port 74 continuously passes through the optical paths of the inspection light L1 and the scattered light L2 in the process of being discharged from the discharge port 75, and thus the measurement fluid stored in the cell 2 can be continuously measured. Note that both the introduction port 74 and the discharge port 75 may be arranged on one side or the other side in the axial direction D3 with respect to the inspection light L1 and the scattered light L2.

The reinforcing member 53 and the wiper fixing portion 52 include a discharge flow path 76 communicating with the discharge port 75. The discharge flow path 76 communicates with the discharge pipe 72 via a flow path (indicated by broken lines in FIG. 10) formed inside the columnar portion 7b and the rectangular portion 7a.

The housing 8 covers the cell 2, the first holder 21, the second holder 22, and the base 7. In the housing 8, at least a portion covering the outer peripheral surface of the cell 2 is preferably formed in black so as to absorb light. Further, the housing 8 supports the light source 3 and the detector 4 at predetermined positions.

As described above, the measurement system 101 according to the present embodiment includes the measurement device 102 and the communication device 103 capable of communicating with the measurement device 102.

Then, as in the present embodiment, the measurement device 102 includes the measurement instrument 104 and the main body 105 to which the measurement instrument 104 is attached and detached.

As in the present embodiment, the measurement instrument 1 includes the cylindrical cell 2 that stores the measurement fluid, the light source 3 that is arranged outside the cell 2 and irradiates the measurement fluid with the inspection light L1, the detector 4 that is arranged outside the cell 2 and detects the scattered light 12 generated from the measurement fluid, the cleaning mechanism 5 that is arranged inside the cell 2 and cleans the inner peripheral surface of the cell 2, and the drive mechanism 6 that rotates the cell 2 about the central axis CL.

With such a configuration, since the inner peripheral surface of the cell 2 is cleaned by rotating the cell 2 with respect to the cleaning mechanism 5 fixed inside the cell 2, the light emitted from the light source 3 is not blocked by the cleaning mechanism 5, and the measurement can be continuously performed.

In addition, as in the present embodiment, a preferable configuration is that the cleaning mechanism 5 is arranged outside the optical paths of the inspection light L1 and the scattered light L2.

With such a configuration, the cleaning mechanism 5 does not interfere with the measurement.

In addition, as in the present embodiment, a preferable configuration is that the cleaning mechanism 5 is arranged between the light source 3 and the scattered light detector 4 in the rotation direction RD of the cell 2.

With such a configuration, the cleaning mechanism 5 does not interfere with the measurement.

In addition, as in the present embodiment, a preferable configuration is that the detector 4 is the scattered light detector 4 that detects scattered light, and the cleaning mechanism 5 blocks stray light.

With such a configuration, the cleaning mechanism 5 suppresses stray light from being received by the scattered light detector 4, and thus more accurate measurement can be performed.

In addition, as in the present embodiment, a preferable configuration is that the cleaning mechanism 5 includes the wiper 51 in contact with the inner peripheral surface of the cell 2.

With such a configuration, the inner peripheral surface of the cell 2 can be wiped and reliably cleaned by the wiper 51.

In addition, as in the present embodiment, a preferable configuration is that the introduction port 74 through which the measurement fluid is introduced into the cell 2 and the discharge port 75 through which the measurement fluid is discharged from the cell 2 are provided.

With such a configuration, the measurement fluid stored in the cell 2 can be continuously measured.

In addition, as in the present embodiment, a preferable configuration is that the discharge port 75 is located above the introduction port 74.

With such a configuration, air accumulated in the upper portion of the cell 2 can be discharged from the discharge port 75.

In addition, as in the present embodiment, a preferable configuration is that the first holder 21 and the second holder 22 having a cylindrical shape and connected to both sides of the cell 2 in the axial direction D3 are provided, and the cell 2 rotates integrally with the first holder 21 and the second holder 22.

With such a configuration, the cell 2 can be rotated by rotating the first holder 21 by the drive mechanism 6.

In addition, as in the present embodiment, a preferable configuration is that the first holder 21 and the second holder 22 each include the two O-ring grooves 211, 212, 221 and 222 formed apart from each other in the axial direction D3 in inner peripheral surfaces of the first holder 21 and the second holder 22, and the first holder 21 and the second holder 22 are attached to the outer peripheral surface of the cell 2 via O-rings 23a, 23b, 23c, and 23d disposed in the O-ring grooves 211, 212, 221, and 222.

With such a configuration, it is possible to increase the frictional force between the cell 2 and the first holder 21 or the second holder 22 while ensuring the sealing property between the cell 2 and the first holder 21 or the second holder 22 and preventing the measurement fluid from leaking to the outside of the cell 2, and to rotate the cell 2 and the second holder 22 by the rotation of the first holder 21.

In addition, as in the present embodiment, a preferable configuration is that the drive mechanism 6 is arranged outside the cell 2 and at a position away from the cell 2 in the axial direction D3 of the cell 2.

With such a configuration, the drive mechanism 6 can rotate the cell 2 without interfering with measurement.

In addition, as in the present embodiment, a preferable configuration is that the drive mechanism 6 includes the motor 61, the drive gear 62 rotationally driven by the motor 61, and the driven gear 63 that rotates in mesh with the drive gear 62, and the driven gear 63 is fixed to the first holder 21 and rotates the first holder 21 about the central axis CL of the cell 2.

With such a configuration, the drive mechanism 6 can rotate the cell 2.

Note that the measurement system 101, the measurement device 102, and the measurement instrument 1 are not limited to the configurations of the above-described embodiments, and are not limited to the above-described operations and effects. In addition, it is a matter of course that various modifications can be made to the measurement system 101, the measurement device 102, and the measurement instrument 1 without departing from the gist of the present invention. For example, it is a matter of course that one or a plurality of configurations, methods, and the like according to the following various modification examples may be arbitrarily selected and employed in the configurations, methods, and the like according to the above-described embodiments.
(1) The measurement instrument 1 according to the above embodiment has a configuration in which the detector 4 is a scattered light detector that detects the scattered light L2, and the cleaning mechanism 5 is arranged between the light source 3 and the scattered light detector 4 in the rotation direction RD of the cell 2. However, the measurement instrument 1 is not limited to such a configuration. For example, a configuration may be employed in which the detector 4 is a transmitted light detector that detects transmitted light, and the cleaning mechanism 5 is arranged between the light source 3 and the transmitted light detector in the rotation direction RD of the cell 2. At this time, the transmitted light detector is arranged so as to face the light source 3 across the central axis CL of the cell 2.
(2) In the measurement instrument 1 according to the above embodiment, the cleaning mechanism 5 is configured to include the wiper 51 in contact with the inner peripheral surface of the cell 2. However, the measurement instrument 1 is not limited to such a configuration. For example, a configuration may be employed in which the cleaning mechanism 5 includes a brush that contacts the inner peripheral surface of the cell 2. Further, the cleaning mechanism 5 is not limited to the configuration in which the inner peripheral surface of the cell 2 is wiped with a wiper, a brush, or the like, and may be configured to clean the inner peripheral surface of the cell 2 with air or liquid. At this time, a structure for preventing air and liquid used for cleaning from leaking from the cleaning mechanism 5 into the cell 2 is separately required.
(3) The measurement instrument 1 according to the above embodiment is configured to include the introduction port 74 for introducing a measurement fluid into the cell 2 and the discharge port 75 for discharging the measurement fluid from the cell 2. However, the measurement instrument 1 is not limited to such a configuration. For example, the measurement instrument 1 may be configured to measure the fluid filled in the cell 2 by immersing the cell 2 in the fluid without including the introduction port 74 and the discharge port 75.
(4) In the measurement instrument 1 according to the above embodiment, the direction in which the introduction pipe 71 and the discharge pipe 72 are arranged in parallel is defined as the second lateral direction D2, and the direction orthogonal to the second lateral direction D2 and the vertical direction D3 is defined as the first lateral direction D1, but the directions are not limited thereto. For example, the direction in which the introduction pipe 71 and the discharge pipe 72 are arranged side by side may be the first lateral direction D1. Furthermore, the first lateral direction D1 or the second lateral direction D2 is not necessarily parallel to the direction in which the introduction pipe 71 and the discharge pipe 72 are arranged side by side.

### DESCRIPTION OF REFERENCE CHARACTERS

1 Measurement instrument
1a Measurement unit
1b Case
1c Cover
2 Cell
2r Radius of inner peripheral surface of cell
3 Light source
4 Detector (scattered light detector)
5 Cleaning mechanism
6 Drive mechanism
7 Base
7a Rectangular portion
7b Columnar portion
8 Housing
21 First holder
21a First connection portion
21b Closing portion
22 Second holder
22a Second connection portion
22b Extension portion
23a O-ring
23b O-ring
23c O-ring
23d O-ring
24 X-ring
31 LED substrate
32 Reference light detection unit
41 Photodiode substrate
51 Wiper
51a Contact portion
52 Wiper fixing portion
52r Radius of wiper fixing portion
53 Reinforcing member
61 Motor
62 Drive gear
63 Driven gear
64 Bearing
65 Gear base
66 Bearing
71 Introduction pipe
72 Discharge pipe
73 Introduction flow path
74 Introduction port
75 Discharge port
76 Discharge flow path
211 O-ring groove
212 O-ring groove
221 O-ring groove
222 O-ring groove
CL Central axis
L1 Inspection light
L2 Scattered light
RD Rotation direction of cell
101 Measurement system
102 Measurement device
102a Inflow portion
102b Outflow portion
102c Flow path
103 Communication device
103c Input unit
103d Output unit
103e Acquisition unit
103f Storage unit
103g Calculation unit
103h Control unit
103i Processor
103j Memory
103k Interface
103m Program
104 Measurement instrument
104a Measurement flow path
104b Measurement unit
104c Input unit
104d Output unit
104e Acquisition unit
104f Storage unit
104g Calculation unit
104h Control unit
104i Processor
104j Memory
104k Interface
104m Program
105 Main body
105a Main body flow path
105c Input unit
105d Output unit
105e Acquisition unit
105f Storage unit
105g Calculation unit
105h Control unit
105i Processor
105j Memory
105k Interface
105m Program
CL Central axis
D1 First lateral direction
D2 Second lateral direction
D3 Vertical direction (axial direction)
X1 Communication means

1. A measurement instrument comprising:
a cylindrical cell that stores a measurement fluid;
a light source that is arranged outside the cell and irradiates the measurement fluid with inspection light;
a detector that is arranged outside the cell and detects transmitted light or scattered light generated from the measurement fluid;
a cleaning mechanism that is arranged inside the cell and cleans an inner peripheral surface of the cell; and
a drive mechanism that rotates the cell about a central axis.

2. The measurement instrument according to claim 1, wherein the cleaning mechanism is arranged outside optical paths of the inspection light, the transmitted light, and the scattered light.

3. The measurement instrument according to claim 1 or 2, wherein the cleaning mechanism is arranged between the light source and the detector in a rotation direction of the cell.

4. The measurement instrument according to claim 3, wherein
the detector is a scattered light detector that detects scattered light, and
the cleaning mechanism blocks stray light.

5. The measurement instrument according to any one of claims 1 to 4, wherein the cleaning mechanism includes a wiper or a brush in contact with the inner peripheral surface of the cell.

6. The measurement instrument according to any one of claims 1 to 5, further comprising an introduction port through which a measurement fluid is introduced into the cell, and a discharge port through which the measurement fluid is discharged from the cell.

7. The measurement instrument according to claim 6, wherein the discharge port is located above the introduction port.

8. The measurement instrument according to any one of claims 1 to 7, further comprising
a first holder and a second holder having a cylindrical shape and connected to both sides of the cell in an axial direction, wherein
the cell rotates integrally with the first holder and the second holder.

9. The measurement instrument according to claim 8, wherein
the first holder and the second holder each include two O-ring grooves formed apart from each other in the axial direction in inner peripheral surfaces of the first holder and the second holder, and
the first holder and the second holder are attached to an outer peripheral surface of the cell via O-rings disposed in the O-ring grooves.

10. The measurement instrument according to any one of claims 1 to 9, wherein the drive mechanism is arranged outside the cell and at a position away from the cell in an axial direction of the cell.

11. The measurement instrument according to claim 8 or 9, wherein
the drive mechanism includes a motor, a drive gear rotationally driven by the motor, and a driven gear that rotates in mesh with the drive gear, and
the driven gear is fixed to the first holder and rotates the first holder about the central axis of the cell.

12. A measurement device comprising:
the measurement instrument according to any one of claims 1 to 11; and
a main body to which the measurement instrument is attached and detached.

13. A measurement system comprising:
the measurement device according to claim 12; and
a communication device capable of communicating with the measurement device.

14. A measurement method using a measurement instrument, the measurement instrument including:
a cylindrical cell that stores a measurement fluid;
a light source that is arranged outside the cell and irradiates the measurement fluid with inspection light;
a detector that is arranged outside the cell and detects transmitted light or scattered light generated from the measurement fluid;
a cleaning mechanism that is arranged inside the cell and cleans an inner peripheral surface of the cell; and
a drive mechanism that rotates the cell about a central axis.
